(19) United States
(12) Patent Application Publication
(10) Pub. No.: US 2009/0046842 A1
(43) Pub. Date: Feb. 19, 2009

(54) COMMUNICATION SYSTEM AND METHOD

(76) Inventors: Malcolm Evatt Keith Allen, Victoria (AU); Gregory Rolan, Victoria (AU)

Correspondence Address: FITCH EVEN TABIN AND FLANNERY, 120 SOUTH LA SALLE STREET, SUITE 1600, CHICAGO, IL, 60603-3406, US

(21) Appl. No.: 12/094,053

(22) PCT Filed: Nov. 17, 2006
(86) PCT No.: PCT/AU2006/001738

§ 371 Date: Sep. 5, 2008

(30) Foreign Application Priority Data
Nov. 18, 2005 (AU) 2005906435
Jul. 14, 2006 (AU) 2006903816

(51) Int. Cl. H04M 3/42

(52) U.S. Cl. 379/201.01

(57) ABSTRACT

A communication system, for A-Party Call Control comprising a Directory Storage from which data can be retrieved by an A-Party Device and for storing one or more directory entries for each Entity intended to be communicated with using the communication system, at least one of the one or more directory entries of each Entity associated with one or more Communication Identities, whereby an authorised A-Party Device seeking to request, establish, or maintain communication with a B-Party can obtain at least one Communication Identity for the B-Party, and a Communication Status Mechanism to enable an authorised A-Party Device to derive and confirm the current communications capabilities and one or more Effective Ring Timeout Parameters (RTPs) for at least one of said one or more B-Party Communication Identities and to determine whether there is at least one viable Effective RTP which can be employed to control an attempt to request, establish, or maintain communication with a B-Party.

### FIELD

The present invention relates to a communication system and method. One example of the invention enables users of a communications network to control real time communications methods including before a request for communication is initiated, after a request for communications has been initiated but before the request has been granted or completed in some other way, and during communications.

### BACKGROUND TO THE INVENTION

“Entities” use “Devices” to communicate. Entities may be subscribers to, or users of, communications services and may be human individuals using Devices, organisations with human representatives using Devices, and may also be systems that can communicate, for example programmed computer systems such as Interactive Voice Response Systems. Devices connect Entities to Networks. Examples of Devices are telephones and computers running communications software.

A Device may connect to several Networks. Each Network will have at least one associated “Communications Function Endpoint” (CFE) in the Device that provides the functionality to enable an Entity to connect to the Network using the Device and provides functionality to facilitate communications, such as to translate the Network protocol to/from audible speech for a voice CFE, once the device is connected. The capability of the Device may determine the capability of the CFE on the Device. For example some Devices may allow video communications and others voice.

Typically Networks are not directly aware of the Entity using each Device. So, for example, a Network can generally not direct calls to an Entity, it can only direct calls to a Device at a particular address and the calling party makes the assumption that the address is associated with the Entity of interest. An A-Party Entity will select a CFE with which to place a call to a B-Party Entity, the choice typically being made on the basis of the A-Party's assumptions about availability, cost and quality of the device/CFE or Network.

Traditional real-time communications Networks use “Network Call Control” to manage the routing and management of the calls and communications before, during and after the initiation, execution and termination of communications between A-Parties and B-Parties. With Network Call Control, each Network internally maintains information about the state and connection rules of each Device attached to the Network and routes calls within the Network accordingly. For example an Entity originating communications over a Network, an “A-Party” Entity, could use an A-Party Device to place a call on a given Network to the expected Network address, such as the phone number, of an intended receiving, or “B-Party”, Device. If the B-Party Device is already conducting a call, i.e. “busy”, the Network itself may use predefined rules that redirect the call to another address such as an in-Network voicemail system.

Network Call Control actions may be driven by rules relating to A-Party Devices, Networks and/or B-Party Devices and may use rules relating to non-Network related factors such as the time-of-day or Entity calendar events.

A-Party rules and B-Party rules provide call maintenance and termination instructions for the Network based on the communicating Devices, their respective addresses, or the commercial account statuses of the address. Such rules might be “terminate the call if the B-Party Device requests to do so”, or “terminate the call if the A-Party account balance is zero”. While such rules may be based on instructions from the A-Party or B-Party Entities, they are implemented within the Network in respect of the A-Party or B-Party Devices.

Network rules handle management of the call across the Network during the establishment, execution or termination of communications. Such a rule might be, “send or play a certain message then an engaged signal to all A-Party Devices trying to dial a network (such as the PSTN network of another country) if the originating network cannot establish a connection to the destination network”.

Network rules also handle management of the call within the Network during the execution or termination of communications. For example: if the B-Party Device changes cell in a mobile Network, the Network rules determine when and how to transfer the call to the new cell to maintain communications.

B-Party rules are rules that determine the intervention a Network should take once a call can reach a B-Party Device's address or an address derived from applying other rules. Such a rule might be, “forward calls to another address if this address is busy”.

Call control rules may also specify the time after call initiation that the Network should intervene. In Network Call Control most A-Party Device and Network rules are invoked immediately. In the case of B-Party rules, for a given address, the network typically will not intervene with a call control rule until the specified duration after call initiation and there may be a different rule with a different duration time depending on the state of the B-Party Device, such as depending on whether the B-Party Device is available, off-network, busy or in some other state. For example, if an address is busy, when a call is attempted to be placed to that address the Network may immediately intervene, such as by redirecting the call to voicemail, whereas if an address is in an available state, the Network will send a “ring” signal to that address for, say, 20 seconds on call initiation, and then after 20 seconds will redirect the call to voicemail if it is unanswered.

As Network-connected Devices have become more intelligent they have become able to perform some of the call control functions associated with Network Call Control. In particular the functions normally associated with B-Party rules can now be performed by B-Party Devices such as PABXs and these may be called “B-Party Call Control” functions. B-Party Devices may be able to receive a call and then switch it if necessary to a local voicemail machine if an extension is busy, or forward the call to another extension, or even redirect the call back out into the network to other third address. Thus the B-Party Call Control functions substitute for Network Call Control functions based on rules similar to those of Network Call Control. B-Party Call Control may even achieve some “awareness” of Parties using the network and, for example, adjust the destination address based on an implied location of the called B-Party.

Accordingly, it will be appreciated that existing types of call control are generally exercised at the convenience of the Network or the B-Party device—regardless of the A-Party's preferences. At the same time, it is generally the case that the A-Party incurs the cost for the call, regardless of the intervention by the B-Party Device and often also regardless of the intervention of the Network. Also the scope of operation of existing types of call control is, by definition, within a single Network. While it may be the case that both the A-Party and B-Party devices may be connected to several common networks, the A-Party can only select one CFE with which to place the call. In addition, whilst the relationship between the parties may be such that the B-Party is better-placed to initiate the call (either for cost, quality or timing considerations), there is no network mechanism for the A-Party to request such a “call-back” from the B-Party—save placing a call to request it!

During the course of the call, the set of common networks or their attributes may change giving the parties additional options for the call in terms of network availability, quality or cost. The Network Call Control employed by the Network selected by the A-Party, however is unaware of the other available networks and cannot take part in any maintenance of the call to optimise communications across other Networks.

Similarly, Network Call Control can facilitate anonymous calling from within a single network (for example, through hiding caller-id) but cannot avail itself of communications across the set of common networks which both parties may share in order to ensure anonymous communications. For example, if a network does not support B-Party anonymity through one-time addresses, communications cannot generally be established on a common network which does support such facilities.

Networked CFEs may have “Presence States” associated with them or their addresses, which are published for the convenience of other Network users. “Presence” indicates availability and willingness of an Entity to use a particular CFE to communicate on a particular Network with other parties. Examples of Presence States are “away”, “call me”, or “do not disturb”. Presence information may be published by a Device, CFE or by the Network itself. Some Networks allow Presence information to be shared between Networks, particularly if the Networks have interconnect arrangements to enable communications between Devices or CFEs on both Networks.

Some Networks allow Presence information to be customised to provide additional Context information about an Entity. This “Context” customised Presence information provides information which is not directly available from the communications Device but which may aid in determining the most appropriate means of communicating with an Entity using that Network. For example “call me” as a Presence State contains more context information than “available” but both relate to the Presence State of a Network attached Device which is available for communications.

Many prior art documents assume that any information they require will be forthcoming from the Network. For example, U.S. Pat. No. 5,600,704 discloses network-based timing information being used by a switch to determine the time allowed for a call to ring. This patent assumes Network Call Control is in place (in that all functions happen within the network switching equipment) and although multiple calling sequences are allowed, these are based solely on time of day rather than Presence information.

U.S. Pat. No. 5,579,375 discloses a call forwarding algorithm from a central office switch. This patent does not explain how the “call forwarding number with the highest probability of completing the call” is calculated.

WO 01/45342 uses a central controller model that allows users to specify rules about their Presence. Users can also specify rules about what Presence information they wish to gather about other users but this information is not directly used to drive call control rules.

US 2006/0002327 discloses a network where the traffic receiving availability of other endpoints is stored locally at each endpoint. The information is maintained regularly but will not always be up to date.

EP 15830349 discloses a call control entity (CCE) that acts as an intermediary between a calling party device and a plurality of possible called party devices to prevent the call being terminated at the calling party device during sequential dialing. This requires the calling party to provide numbers for the called party's devices. Further, there is no mechanism that prevents a call being terminated between the CCE and the called party device.

### SUMMARY OF THE INVENTION

In a first broad aspect, the invention provides a communication system for A-Party Call Control comprising:
a Directory Storage from which data can be retrieved by an A-Party Device and for storing one or more directory entries for each Entity intended to be communicated with using the communication system, at least one of the one or more directory entries of each Entity associated with one or more Communication Identities, whereby an authorised A-Party Device seeking to request, establish, or maintain communication with a B-Party can obtain at least one Communication Identity for the B-Party; and
a Communication Status Mechanism to enable an authorised A-Party Device to derive and confirm the current communications capabilities and one or more Effective Ring Timeout Parameters (RTPs) for at least one of said one or more B-Party Communication Identities and to determine whether there is at least one viable Effective RTP which can be employed to control an attempt to request, establish, or maintain communication with a B-Party.

Depending on the embodiment, the Effective RTP may be employed so as avoid interference or termination of the communication by other network elements (for example, the Network, PBXs or B-Party Device), or seek to improve the continuing cost, quality or other factor of the communications. The Effective RTP may be employed to attempt to establish several alternative communications methods with or without A-Party user intervention or A-Party presumption of information regarding the B-Party in parallel or series while avoiding interference.

As Networks are not directly aware of the Entity using each Device, they can generally not direct calls to an Entity, but only direct calls to a Device at a particular address and the calling party makes the assumption that the address is associated with the Entity of interest. This address is termed a “Communications Identity”.

Communication may occur via qualitatively different mechanisms which have different characteristics in terms of cost, fidelity, usability access, and real-time responsiveness,—for example audio (conventional telephony equipment), video (video-phones, video-conferencing equipment, computer-computer applications), messaging (e-mail, Instant-Messaging, facsimile) etc. Particular Networks, Devices and CFE's will support different sets of Channels, which may be expressed as the communications capabilities and which may be associated with a given Communications Identity, Device, or Network. For example, A Communications Identity associated with a Device CFE which supports video and audio will have different Communications Capabilities than if the Device CFE supported audio only.

Communications Capabilities may change over time in response to environmental or other changes. For example, a change from full video to audio-only in the event of a network degradation—while maintaining the Communications Identity, Network And Devices of the current communications.

In an embodiment, the Directory Storage is arranged to store one or more possible Ubieties for an Entity, and capable of optionally associating each Ubiety with the Entity's communications capabilities and one or more RTPs for each Communication Identity, whereby the current RTPs that apply to a B-Party Communication Identity can be determined from the current Ubiety, and the Communication Status Mechanism derives the one or more Effective RTPs at least in part from the current RTPs. For example, the Communication Status Mechanism may be configured to employ prevailing communication capabilities of at least the B-Party or mutual communications capabilities, together with the current RTPs that apply to a B-Party Communication Identity, to derive the one or more Effective RTPs.

In an embodiment communications capabilities may be defined by Presence States, values, durations (for example, a zero Ring Timeout Parameter (RTP) value defining an “unavailable” state) or other qualitative or quantitative indicators from which availability, cost, quality or other characteristic of communications with a Communications Identity and its Channel(s), Network and Device(s) can be derived.

In an embodiment, the Effective RTP is dependent on the prevailing mutual communications capabilities of both Parties. In addition, due to network quality or latency, the RTP may be modified by the A-Party or B-Party depending on the channel used for communication, or other characteristics.

Preferably, in using a current RTP that applies to a B-Party Communication Identity in order to derive an Effective RTP, the Communication Status Mechanism only narrows the options for communications and does not eliminate all options.

In an embodiment, the Directory Storage is also capable of storing the current Ubiety and status overrides for an Entity.

In an embodiment, the Directory Storage also stores associated information for each Communication Identity that enables the requesting, establishing, or maintaining of communications.

Some or all of the current RTPs may be default RTPs.

In an embodiment, the Communication Status Mechanism comprises a Current Status Mechanism which makes available the current Ubiety of a B-Party Entity from which the RTPs associated with the current Communications Identities of the B-Party Entity can be derived. The Current Status Mechanism also makes available status overrides (such as network temporarily unavailable) which enables A-Party Entities to adjust data representing the B-Party communications capabilities (in terms of cost, quality or other factors of the communications) and RTPs implied by a B-Party's current Ubiety and Directory Storage entries, in order to form Effective RTPs. Where there are no status overrides the RTPs obtained from the Directory Storage and current Ubiety can be assumed to be the Effective RTPs.

In an embodiment the Current Status Mechanism stores the current Ubiety and status overrides for a B-Party Entity in the Directory Storage.

In an alternative embodiment the Current Status Mechanism alters the current RTPs in the Directory Storage based on any status overrides whereby the current RTPs provide Effective RTPs.

In an embodiment, Communications Identities obtained for an A-Party or provided by a B-Party may provide anonymity of an Entity—for example, it may be a dynamic or temporary Communications Identity only valid for communications with that other party or one communications session.

In a second broad aspect, the invention provides a communication method for A-Party call control, comprising:
an A-Party Device obtaining one or more Communication Identities for a B-Party;
the A-Party Device deriving and confirming the current communications capabilities associated with at least one of said one or more B-Party Communication Identities including whether there is at least one viable Effective Ring Timeout Parameter (RTP); and
if there is at least one viable Effective RTP:
selecting at least one Communication Identity having a viable Effective RTP with which to request, establish, or maintain communications; and
the A-Party Device controlling the attempt to request, establish, or maintain communications based on the mutual communications capabilities including at least one of the at least one Effective RTP associated with at least one selected Communication Identity.

In an embodiment, the A-Party Device derives the communication capabilities of the Communication Identities at least in part from at least one Ubiety associated with one or more of the Communication Identities.

In an embodiment, the A-Party Device confirms the current communication capabilities, at least in part by determining one or more changes in Ubiety or one or more Status overrides which may affect the B-Party Communication Status associated with the at least one Communications Identity for the B-Party Entity.

In an embodiment the A-Party Device requests and establishes communication by:
performing a ‘Current Status Check’ of the communications capabilities and their current status of itself and the one or more known B-Party Devices to confirm that the mutual communications capabilities are still current and that the B-Party's published or advised Ubiety and any Overrides are still current and confirming that there is at least one Communications Identity with a viable Effective RTP which can be used to request, establish, or maintain communications;
informing the B-Party device of an intent to initiate communications based on the at least one selected Communication Identity and Channel combination associated with the B-Party Entity and receiving acknowledgement;
negotiating with the B-Party device the parameters and conditions of communications, based on the at least one selected Communication Identity and Channel combination associated with the B-Party Entity.

The Current Status Check may include refreshing its own communications capabilities information; re-retrieving relevant B-Party Identiset, Ubiety and Override information using either Identiset and Ubiety information from a directory, or directly requested; re-retrieving Private Identiset, Ubiety and Override information from the B-Party; querying the relevant networks for current status information; and querying the B-Party device, network services or other locations to check that the B-Party communications Services are still available since they were last published or advised by its Ubiety. Those skilled the art will recognise there are many mechanisms for the A-Party to use in obtaining information in the Current Status Check.

Those skilled the art will recognise there are many mechanisms for parties to negotiate communications (for example, the H324 modem training protocol, SIP VoIP streaming protocol and codec negotiation etc.) and this invention does not mandate a particular negotiation scheme.

Typically the result of negotiation will be:
i) the Communications Identity and Channel upon which communications should be initiated;
ii) the Effective RTP for the Communications Identity; and
iii) which Party and Party Device shall initiate and be responsible for coordinating the initiation of communications,
And then the A- or B-Party Device, selected by negotiation, controlling the attempt to transfer communications using the Communication Identity and Channel combination and the other-Party Entity accepting communications using the Identity and Channel combination.

In an embodiment the A-Party Device maintains communication by:
informing the B-Party device of an intent to transfer communications based on the at least one selected Communications Identity and Channel combination associated with the B-Party Entity and receiving acknowledgement;
negotiating with the B-Party device the parameters and conditions of changed communications, based on the at least one selected Identity and Channel combination associated with the B-Party Entity.

Typically, the result of negotiation will be:
i) the Communications Identity and Channel upon which communications should be initiated;
ii) the Effective RTP for the Communications Identity; and
iii) which Party and Party Device shall initiate and be responsible for coordinating the initiation of communications;
and then the A- or B-Party Device, selected by negotiation, controlling the attempt to transfer communications using the new Identity and Channel combination and the other-Party Entity accepts communications using the new Identity and Channel combination;
the Devices synchronising communications with the new Communications Identity, Channel, Network, and/or Device combination; and
the A- or B-Party Device, selected by negotiation, controlling the attempt to maintain communications, terminating communications of the original Identity and Channel combination.

In an embodiment there may be a time delay while the change in communications occurs to allow for any difference in latency between the networks. In this case an in-band signal (including possibly the voices or background noises in the call themselves) can be used to ensure that end-to-end signal propagation across both the connections is the same. This may involve the CFEs associated with the new Channel in one or both Devices caching the call until such time as signal latency is synchronised.

In some embodiments the change of Communications Identity may involve a change of Channel, Network, and/or Device. In some embodiments there may be no change of Communications Identity, only a change of Channel, Network, and/or Device. An example of change of channel is a change from full video to audio-only in the event of a network degradation—while maintaining the Communications Identity, network and devices of the current communications. In some embodiments, there may be no change of Communications Identity, Channel, Network, and/or Device, only a change in A-Party/B-Party designation. In other words, the communications may be re-initiated from the other party in order to change the way costs may be incurred or responsibility for the call is maintained.

In an embodiment, the Entity's multiple devices work in concert to provide Device Based Call Maintenance. For example while a Mobile Phone and PC both provide CFEs for communication, perhaps only the PC may directly be involved in notifying Communication Statuses and initiating Communications Handover—the Mobile Phone only being notified with the result of Device Based Call Maintenance e.g. to hang up the call or swap transport.

Typically the initiator of a change in Communications Identity while engaged in a call will be the A-Party who initiated the call (as typically they incur the cost of the call). However in some embodiments:
the A-Party may allow the B-Party to change the Communications Identity while engaged in a call, for example the B-Party may agree to pay the A-Party if it can avoid network roaming charges; or
the Party whose Current Communications Status changes may initiate a Communications Handover as, while there is no incremental cost to either party, there may be efficiency reasons for one Party to initiate the change.

In a third broad aspect the invention provides a communication method for A-Party Call Control comprising:
a B-Party Device disclosing at least one Communication Identity and corresponding Ubiety associated with a B-Party Entity to an A-Party Entity which may be seeking to request, establish, or maintain communications with the B-Party Entity;
the B-Party Device disclosing communications capabilities including one or more Effective RTPs associated with the at least one Communications Identity for the Entity;
the B-Party Device disclosing one or more changes in Ubiety or Status overrides which may affect the Current Communication Status associated with the at least one Communications Identity for the B-Party Entity; and
the B-Party Device participating in the requesting, establishing, or maintaining of communications based on the mutual communications capabilities including at least one viable Effective RTP of the one or more Effective RTPs of the at least one Communication Identity.

In an embodiment the B-Party Device responds to requests for establishment of communication by offering to “call back” the A-Party and establish communication based on the negotiated set of communications capabilities (e.g. networks, channels, Communications Identities, Ubieties etc.). The call-back, if it occurs after a predetermined condition is met (for example, after a predetermined time, a change in ubiety, or communication status), may result in a re-negotiation of communications capabilities at that time.

In a fourth broad aspect, the invention provides an A-Party Device for A-Party call control, the A-Party Device being configured to:
obtain one or more Communication Identities for a B-Party;
derive and confirm the current communications capabilities associated with at least one of said one or more B-Party Communication Identities including whether there is at least one viable Effective Ring Timeout Parameter (RTP); and
if there is at least one viable Effective RTP:
enable selection of at least one Communication Identity having a viable Effective RTP with which to request, establish, or maintain communications; and
participate in an attempt to request, establish, or maintain communications based on the mutual communications capabilities including at least one of the at least one Effective RTP associated with at least one selected Communication Identity.

In an embodiment, the A-Party Device is configured to derive the communication capabilities of the Communication Identities at least in part from at least one Ubiety associated with one or more of the Communication Identities.

In an embodiment, the A-Party Device is configured to confirm the current communication capabilities, at least in part by determining one or more changes in Ubiety or one or more Status overrides which may affect the B-Party Communication Status associated with the at least one Communications Identity for the B-Party Entity.

In a fifth broad aspect, the invention provides B-Party Device for A-Party call control, the B-Party Device configured to:
disclose at least one Communication Identity and corresponding Ubiety associated with a B-Party Entity to an A-Party Device which may be seeking to communicate with the B-Party Entity;
disclose communications capabilities including one or more Effective RTPs associated with the each at least one Communication Identity, whereby an A-Party Device may initiate requesting, establishment, or maintenance of communications with the B-Party Entity;
disclose one or more changes in Ubiety or Status overrides which may affect the B-Party Communication Status associated with the at least one Communications Identity for the B-Party Entity; and
participate in the requesting, establishing, or maintaining of communications based on mutual communications capabilities including at least one viable effective RTP of the one or more Effective RTPs of at least one Communication Identity.

Parties may disclose information to other Parties directly or via an intermediary. Not all the disclosed information is necessarily made available to all Parties.

The step of selecting at least one Communication Identity may be performed by the A-Party Device displaying one or more Communication Identities to the A-Party Entity and the A-Party Entity providing their selection to the A-Party Device. Alternatively, the A-Party Device may perform the step of selecting automatically based on one or more rules, such as lowest cost, highest quality or preferred network.

In the case of requesting or establishing communications, where there is only one Communication Identity with a viable Effective RTP, then that Communication Identity is selected.

In the case of Communications maintenance, where the only Communication Identity, Channel, Network, and/or Device combination with a viable Effective Communications Status is that which is currently being used for communications, then no Device Based Call Maintenance, other than change of A-Party/B-Party designation, need take place.

In an embodiment, the method involves storing one or more Ubieties for an Entity, each Ubiety optionally associated with one or more Communications Identities of the Entity and their current communications capabilities including RTPs, and the A-Party Device being able to determine the current B-Party Communications Identities and their current communications capabilities including RTPs on the basis of the current Ubiety and uses at least the current RTPs to derive Effective RTPs.

Depending on the embodiment, the current Ubiety may be published as a Ubiety Alias that enables the A-Party device to derive the current RTPs based on a mutually agreed mechanism for interpreting the Ubiety Alias.

In an embodiment, the method comprises obtaining any status overrides from the Current Status Mechanism corresponding to current B-Party communications circumstances that may alter the current RTPs and deriving Effective RTPs based at least in part on any status overrides.

Depending on the embodiment, some or all of the information used in the method (e.g. communications capabilities, RTPs, Ubiety, Status overrides) may be obtained independently of the B-Party Entity or may be obtained directly from the B-Party Entity or disclosed by the B-Party Entity or B-Party Device to the A-Party directly or via an intermediary system such as the Directory Storage.

Controlling the attempt to request, establish or maintain communications may include attempting to establish communications based on different Effective RTPs in turn and abandoning attempts to request, establish or maintain communications to avoid interference if necessary.

Controlling the attempt to request, establish or maintain communication may involve switching from one communication method to another. For example, from a PSTN network to a VoIP network; or from a real-time communication method to an asynchronous method such as Instant Messenger, e-mail etc.

The invention also extends to an A-Party and a B-Party Device configured to carry out the above methods.

Aspects of the invention may combine the above methods.

### BRIEF DESCRIPTION OF THE DRAWINGS

FIG. 1 is a schematic diagram showing the difference between Networks and Transports;

FIG. 2 is a schematic diagram illustrating potential relationships of Entities, Ubieties, Audience and Context;

FIG. 3 illustrates potential communication options between two Entities;

FIG. 4 is a schematic diagram illustrating potential communications options between Entities connected to a variety of Networks and Transports;

FIG. 5 illustrates the calling process of the preferred embodiment; and

FIG. 6 is a schematic diagram of example Communications Tables associated with an Identiset.

### DETAILED DESCRIPTION OF THE INVENTION

This preferred embodiment provides “A-Party Call Control”, whereby a call is established into a Network with the A-Party Device being aware of, or making assumptions about, Network and B-Party Call Control rules and cost, quality or other factors, including RTPs, associated with the Entity and Communication Identities of interest to the A-Party. This information enables an A-Party device to determine whether a call should be established; whether an existing call be re-established in a manner more optimal to one or both parties; and which party should be responsible for the establishment/re-establishment of the call. In many cases, A-Party Call Control is more economical, and provides greater functionality and quality of communication to the A-Party Entity than Network or B-Party Call Control. By enabling the ability to swap A and B-Party roles within a call and by being compatible with network and B-Party Call Control, overall communications cost, quality and functionality is improved.

### Concepts

Several concepts are established in order to facilitate understanding of embodiments of the invention. These are:

### 1. Transports, Networks, Communication Identity,

### Channels and Devices

### 2. A-Party Call Control Advantages and RTPs

### 3. Entities, Identisets and Audiences

### 4. Presence States, Ubiety and Overrides

These are discussed in turn.

### 1. Transports, Networks, Communication Identity, Channels and Devices

Communications occur between two or more Parties over “Transports” and “Networks”. A Transport is the physical infrastructure over which communication occurs and for the purposes of this invention may be broadly considered to be equivalent to layers 0-2 of the OSI 7 Layer Network model. A Network is a separate logical group of Parties who can communicate together directly (i.e. without relaying communications through another Party or a gateway). Each Network has a unique Network name and clusters of Networks may also be known by a single name. Networks and Transports may be connected to each other through gateways or Parties to form larger groupings. For example the fixed line TDM voice network in each country is typically connected to other country's fixed line TDM (time division multiplex) voice networks through gateways forming the international PSTN for voice calls. Networks run over Transports and may span several Transports. For example mobile networks may transit calls over wireless and/or wired networks and end mobile devices may be attached wirelessly or through a wired fixed connection to the network. Several Networks may run over the same Transport but each Network will have independent relations with its Parties.

A “Communication Identity” is the unique address by which an Entity is known on specific Network at a specific time. The Communication Identity is the combination of both the Network address and the Network name. An Entity may have several Communication Identities, such as phone numbers or email addresses, and at different times these addresses may be assigned to different Entities. Communications Identities may be temporary and may be created by both A-Parties and B-Parties in order to facilitate anonymity in communications—for example, a Communication Identity may be valid for one call only.

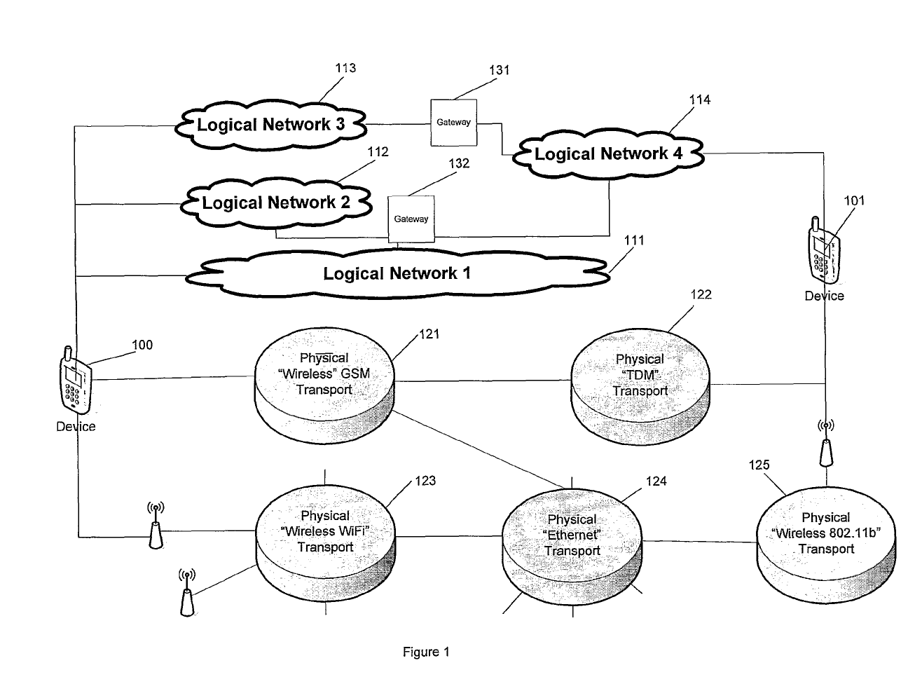

For example, referring to FIG. 1, a VoIP (Voice Over Internet Protocol) capable Transport 123 such as a WiFi wireless protocol may be connected to a certain device 100. That device may be a member of several Networks 111, 112, and 113 all running VoIP services over the same Transport 123. Each of these Networks 111-113 will recognise the device 100 by its own address, unique to their own Network but all communicating over the same Transport. The communications device may also be connected to several Transports: for example, in addition to the VoIP capable transport 123, a device may be connected to a TDM transport 122 and/or a wireless transport 125. And the Networks that the device 100 is connected to 111-113 may in turn be connected to other Networks 114 via gateways 131 and 132 enabling the device 100 to connect to devices connected to those other Networks such as device 101 without requiring all devices to be directly connected to the same Network.

Communications may be further identified as operating on a Channel. Channels may be used to group communications into types facilitating different sorts of interaction between Entities such as “text message”, “text chat”, “audio”, “video” etc. Those skilled in the art will recognise that additional types of Channel may be possible. Transports, Networks and Devices may support more than one Channel and so a Communication Identity may be used to communicate on more than one Channel. For example a Microsoft Messenger CFE may support the messaging, chat, audio and video channels (if the underlying Device does). Depending on capabilities of the Entity, Transport, Network or Device, a “busy” Channel may indicate that it is desirable that no other communications take place on that Channel, and possibly on any Channel. For example, human Entities usually cannot sustain more than one audio communication simultaneously but can handle multiple simultaneous text chat communications. It may be practical for humans to monitor multiple simultaneous video feeds however a hearing-impaired human watching signing language by video may be able to only focus on one feed. Likewise, low-bandwidth Transports or Devices may require that no other communications be initiated if the video channel is busy. Those skilled in the art will recognise additional scenarios which may cause Channel constraints.

The “Device” is intended to mean the Device and its associated CFEs or where communications occurs without a separate Device, such as is possible with communications to or from an automated communications system, the collection of CFEs connected to a common set of Transports associated with the communicating Entity, except where, for example, the description deliberately distinguishes between Devices and CFEs.

### 2. A-Party Call Control Advantages and RTPs

In the embodiments of the present invention, Call Control is exercised by the A-Party Device by allowing the A-Party Device to obtain and use cost, quality or other factors of communication and, in particular, “Ring Timeout Parameters” (RTPs).

RTPs establish the minimum time at which the Network or B-Party is expected to intervene with their prevailing call control rules. Where possible, embodiments of the invention express the RTP as a time interval, for example a number of seconds. However, those skilled in the art will realise that the RTP may not be a time interval but may take other forms, for example “busy” may mean 0 seconds in some contexts and that the Device can be configured to interpret such variables. In some circumstances the lookup of a function expected to result in an RTP may result in no value. In this case an overriding assumption, such as an RTP of 0 seconds may be assumed. An RTP may take a number of different values depending on the state of the B-Party address in particular circumstances, such as “available”, “unavailable” or “busy”. RTPs may also have other characteristics apart from duration, such as an “off” characteristic (RTP 0 seconds) or an “on” characteristic (RTP undefined or defined as a general RTP override of say 20 seconds). A particular RTP may only apply in certain circumstances independent of Network or B-Party, such as time-of-day. The “Effective RTP” is the RTP derived from the application of any method which results in an RTP which is actually used to control establishment of communications. Control occurs on two levels. First, the A-Party Device determines the cost, quality or other factors of communications and whether an RTP is viable or non-zero (e.g. the network or B-Party device will not immediately intervene in the establishment of the call) in which case the Device can initiate or re-establish a call; or request a call-back from the B-Party device (in which case the B-Party device assumes the role of A-Party Device). Second, the A-Party Device can then initiate or re-establish the call and use viable Effective RTPs to take action up until the end of the time interval of the RTP to avoid known intended interference by the Network or B-Party.

Accordingly, as will be discussed in more detail below, a Device may attempt to initiate or re-establish a call to a specific Entity having a plurality of Communication Identities by placing calls to the Communication Identities in an order specified by rules accessible by the A-Party Device. The A-Party Device determines the Effective RTPs to use for each of the plurality of Communication Identities from a variety of data obtained from the B-Party and other sources including, but not limited to: explicit RTPs, Ubieties or Ubiety-related information such as location and disposition; and the override status of Devices, Networks, Transports and Channels.

The A-Party Device only initiates calls to Communication Identities with a viable (i.e. non-zero) Effective RTP and then only for a duration up to, but not including, the duration of the RTP. In this way, baring unanticipated Network or B-Party intervention, the A-Party Device remains in control of communications to Communication Identities for which it has an Effective RTP. The initiation of communications which remain unanswered at the expiration of the RTP may be abandoned by the A-Party Device before Network or B-Party Call Control rules intervene.

Communications to B-Parties where an RTP cannot be established, and where the A-Party does not make some overriding assumption, such as “only allow a maximum of 20 second setup for international calls”, are treated as traditional calls and are subject to Network Call Control and/or B-Party Call Control. The A-Party Device does not programmatically intervene in these calls. Hence an A-Party Call Control enabled Device using RTPs is compatible with existing Network and B-Party Call Control architectures.

A-Party Call Control generally results in more efficient network utilisation and a better user experience than Network Call Control or B-Party Call Control as calls are only placed when there is an expectation that they will connect with the actual B-Party Entity of interest. A-Parties may only choose to incur call costs when calls are actually answered by the B-Party or redirected, such as to an in-Network or B-Party answering service or other address, under the explicit direction of the A-Party.

A-Party Devices using A-Party Call Control can also make choices based on efficiency with regards to Network, Transport and Channel selection and switching. Many electronic communications Devices, such as some mobile phones, have the ability to connect simultaneously to many Transports and Networks. For example some mobile phones can connect simultaneously both to wide area GSM/CDMA mobile Transports and Networks and local area WiFi/Bluetooth wireless Transports and Networks. In order for the Device to establish or re-establish a call optimally it must choose which Transport and Network is most efficient and effective in placing the call and this in turn depends partly on the Transport and Network being used by the B-Party Entity of interest. Devices that can connect to multiple Transports and Networks using a simple heuristic that always gives priority to the local area wireless Network if this is available will result in sub-optimal routing of the call in many instances. For example in the case where both Entities have Devices connected to the same wide area wireless Network but only the A-Party is connected to the local area wireless network, using the simple heuristic the call typically travels through three Transports (the local area wireless, a local area fixed and then the wide area wireless Transport) when it could have traveled through one wide area wireless Transport only. If the A-Party Device is aware of the available Networks and Transports of Devices related to the B-Party Entity before establishing the call it can, through A-Party Call Control, optimise the call setup to enable the call to travel only through the one Network connection where appropriate.

### 3. Entities, Identisets and Audiences

Herein Entities use Devices to communicate. Entities may be subscribers to, or users of, communications services, may be human individuals using Devices or organisations with human representatives using Devices, and may also be systems that can communicate over Networks, for example programmed computer systems such as Interactive Voice Response Systems. Devices connect Entities to networks. Examples of Devices are telephones and computers running communications software. Devices contain CFEs that provide the actual functionality to enable an Entity to connect to a particular Network and use the Network to communicate with other Entities by using the Device.

Entities have a collection of “Identity” information that describes information relating to the Entity and which may be made available to another Entity. Prior to such disclosure, the Identity information may be transformed into “Claims” which provide different or less information than the original Identity but rely upon it. For example a Claim that an entity is over 18 years old has less information than the certified birth date Identity of the Entity. Identity information and Claims may have associated credentials which verify their authenticity. Such credentials (for example certificates) are produced by Identity Providers responsible for the integrity of the Identities and Claims they provide.

Identity information includes:
possible addresses where an Entity may be contacted over communications Networks, “Communication Identities”, along with associated Identity characteristics such as Device, Transport, Channel, and Network identifiers and other communications-related parameters including default RTPs, and
other sorts of information relevant to other contexts such as physical street addresses, Bank account details or medical records details.

Entities may identify themselves in the Directory Storage by Identities other than Communication Identities, for example medical record number or physical address, which enable them to be uniquely identified in the Directory Storage.

More formally, an “Identiset” is the set of Identity information, including Communication Identities that an Entity wishes to make available to a particular Audience. An Identiset may include the following:
a. The list of Identities, including Communication Identities, and Claims that an Entity wishes to disclose to an Audience,
b. Associated Communications Tables, together with a specification of recommended communications alternatives if real time communications fails, if necessary,
c. Any Device, Channel, Transport, or Network overrides of Communications Tables if necessary,
d. Associated Context description for each Ubiety that may be associated with the Entity while it is in that Ubiety, and
e. Associated credentials if necessary, (for example, PKI certificates and keys) directory metadata, etc.

Entities may have relationships with other Entities where they wish to have knowledge of Identity and Claims information of each other. A group of Entities with similar propinquity, to whom an originating Entity seeks to provide the same Identiset, is called an “Audience”.

Directory entries contain Identisets of the Entity. Directory Entries may also contain other non-Identity related information, for example authorised communications paths to an Entity or indexing metadata, that an Entity wishes to make available to Audiences.

The Directory Storage is configured to enable the Entities to specify one or more Identisets for disclosure to different Audiences. The Directory Storage is also configured to allow Entities to associate one or more Communication Identities with related Identisets by Audience. Entities publish directory entries in the Directory Storage in the form of Identisets either directly from the Entities' Devices or indirectly via some intermediary agent (such as a service provider's interface to the Directory Storage). In addition to a published public Identiset, the Entity may make available on at least one of the Entity's Devices or in the Directory Storage at least one private Identiset available only to certain private Audiences. In an embodiment the private Identisets are made available for authorised Entities, as members of those private Audiences, should those Entities or their Devices seek the private Identiset directly from an Entity or the Directory Storage. Devices have an “Entity Dialler” to enable A-Party Entities to identify B-Party Entities that they are potentially interested in communicating with and to retrieve related Identisets and other information, such as Ubiety. Devices are configured to request and retrieve, decrypt and interpret Identisets.

### 4. Presence States, Ubiety, and Overrides

In order to enable a higher level of abstraction than the previously described concepts of Presence or Context, the concept of “Ubiety” is employed. Ubiety provides a mechanism for an Entity to make representations to particular Audiences regarding the collective availability and Presence States of its Communication Identities.

Ubiety is a function of Device and CFE capability, Entity location, the Entity's “Disposition” or receptiveness to receiving communications, and the real-time availability of Devices, CFEs, Transports, Networks and Channels. For example, the Ubiety as a result of the Entity being at the location “at office”, disposition “working”, Voice Channel “engaged” can imply a different set of Transports and Communication Identity Presence States to an Audience, than Location “at airport”, Disposition “receptive to public communications”, Voice Channel “not engaged”, Transport WIFI “unavailable”; or Location “home”, Disposition “not working”, Voice Channel “engaged”. Those skilled in the art will realise that both Location and Disposition are, themselves generalisations and the specificity or granularity of these elements is dependent at least partly upon the Entity's ability to specify them or the Device's capability to determine them automatically.

The Presence State for a particular Communication Identity given by a chosen Ubiety, may be overridden by the actual Presence State of a Communication Identity as provided by the Network or the Device's actual experienced Presence State for that Communication Identity in some instances.

For example the representation of the Presence State “Available” for a VoIP Communication Identity obtained from a Ubiety derived from Location “at office”, Disposition “working” of a particular Entity may, in the event of a temporary Network failure detected by the Device, be overridden temporarily to be “Unavailable” for that particular Network. Such Overrides may be published by the Current Status Mechanism into the Directory Storage along with any Identisets but may also be communicated from an Entity Device to Audiences either automatically as an exception update or as the result of a request from an authorised Entity. The Effective RTP for a given Communication Identity may, at any given point in time, be dependent on not only the Entity's Ubiety (derived from, say, location and disposition), but also on any Device, CFE, Transport, Network, Channel or other override information currently in effect.

The Presence State of a given Communication Identity may be associated with an RTP where, for example, a value of zero may mean ‘do not attempt communication’, and a non-zero value may represent the timeout duration after which an attempted call is to be abandoned. The Presence State may also be associated with other attributes which A-Party Call Control may take into account. These may be quantitative metrics, for example bandwidth, latency, or priority as well as qualitative assessments such as “high quality” or “preferred”.

In the preferred embodiment, the Directory Storage stores a plurality of potential Ubieties for each permutation of possibly available Communication Identity, Device, Transport, and Channel or a subset thereof, each combination optionally associated with an RTP and other communications metrics whereby the A-Party Device can determine the relevant RTP, if any, on the basis of the Ubiety obtained from the Current Status Mechanism.

The A-Party Device determines whether there is a currently relevant RTP for at least one Communications Identity by using the Ubiety information obtained from the Current Status Mechanism to interpret the information obtained from the Directory Storage.

The A-Party Device, after obtaining relevant RTP and communications metrics, obtains the details of any prevailing Device, CFE, Transport, Network RTP or Channel overrides from the Current Status Mechanism and adjusts the RTP appropriately to derive an Effective RTP for each relevant Communications Identity.

In an alternative embodiment, the A-Party Device obtains a set of current RTPs and communications metrics corresponding to each permutation of Communication Identity, Device, Transport, and Channel or a subset thereof, from the Current Status Mechanism to determine whether there is a relevant RTP corresponding to the B-Party Communication Identities.

In an embodiment, the A-Party Device may store the set of possible RTPs and communications metrics in a local cache.

In an alternative embodiment, the Effective RTP Mechanism updates the information stored in the Directory Storage whereby the Effective RTPs and communications metrics, if any, can be retrieved directly without requiring interpretation by the A-Party device.

In an embodiment, when a B-Party Entity has a plurality of Communication Identities that an A-Party Device is authorised to obtain, the Directory Storage enables the A-Party Device to retrieve some or all of the Communication Identities and the Current Status Mechanism enables the A-Party Device to determine an RTP, if any, corresponding to the Presence State for each Communication Identity, thereby enabling control of establishment of communication by an A-Party Device to include an assessment of the potential for interference in respect of different Communication Identities. Typically each Entity is associated with one or more Devices with which the Entity may communicate.

Each Device on each Network is associated with one or more “Communication Identities” and possesses one or more CFEs. Communication Identities are those Identities that enable communications between Entities and can have an RTP associated with them. An example of a Communication Identity is a phone number. Some Networks allow Entities to use the same Communication Identity simultaneously on a plurality of Devices or CFEs, whereby the Entity may initiate or receive communications on any of the Devices using the same Communication Identity.

It is preferred that each Communication Identity has associated information which may include but is not limited to:
a. The Network Address to which it relates,
b. Its associated Network, Devices, Transports and Channels
c. Various credentials (for Example PKI certificates) validating the Identity at the Device, its uniqueness and various other characteristics,
d. Characteristics such as default RTPs for the Communication Identity and permutations of Device, Transport and Channel,
e. other communications metrics and other characteristics.

Typically B-Parties desire to and may disclose different sets of Ubiety and Identiset information to different Audiences for reasons of security and privacy.

The communications information is typically provided in the Directory Storage in the form of Communications Tables published by the Entity. In an embodiment, the invention employs Identisets to control access of Devices to Identity information. In this embodiment, Communications Tables are associated with Identisets that contain Communication Identities.

Preferably, the Communications Tables are configured so that the normal Presence State of an Entity's Communication Identities can be derived from a Ubiety published in the Ubiety Storage and/or Current Status Mechanism by an Entity. In this embodiment, the use of Ubiety enables an Entity to publish a single Ubiety condition (e.g. “At Work”) that can be related to specific Presence States in the Communications Tables for each of the Entity's Communication Identities and tailored to each Audience of an Entity through Identisets.

Devices publish the current Ubiety of their associated Entity and/or status overrides corresponding to their associated Communication Identities, Devices, CFEs, Networks, Transports and Channels.

A Presence State may be overridden by the A-Party Device based on incidental network conditions or other factors, (alternatively the Device may publish raw information from which a Ubiety, Override or Presence State can be derived) in the Effective RTP Mechanism associated with the Entity.

Alternatively Devices may require interested Entities or their associated Devices to communicate directly with them to retrieve their Current Status.

The Entity's Ubiety, Presence State, RTPs, communications information and/or override information may be manually set by an Entity selecting specific communications-related parameters for example by choosing a disposition (such as “I only want to receive calls from certain audiences at this time”) or automatically set (such as the Ubieties “Busy on a voice call so unavailable for new calls”, triggered by a Device state, or “At desk and available” triggered by a location service, or changes in preferred communications methods, such as “Connection Quality Low on this Transport”). Those skilled in the art will realise that other permutations of automatic/manual mechanisms are possible. This information may then be made available via the Directory Storage or Effective RTP Mechanism or communicated directly to other authorised Entities.

The Entity's Current Status is made available for authorised Audiences should other Entities or their Devices seek the Presence State directly from an Entity or the Directory Storage.

Devices are configured to display the Ubiety and/or Presence States and/or their Overrides and/or other Identity or Identiset information of Entities of interest to the Entity associated with a Device.

Devices are configured to identify and order mutually compatible communications alternatives between Entities from the range of communications alternatives derived from:
the A-Party Device's available communications alternatives,
the Communication Identities determined from the B-Party's Identiset,
available Communication Identities determined from the B-Party's Communications Tables and Ubiety and/or
adjustments derived from Device, CFE, Network, Transport or Channel overrides of the B-Party Entity of interest.

The list of mutually compatible communications alternatives between Entities and/or associated Communications Parameters, including RTPs, may be refined in real-time based on the success, lack of success, or performance of communications attempts and/or connections.

A-Party Devices may also use other information such as user preference information or cost/quality metrics to determine the preferred communications method from the alternatives. In an embodiment, A-Party Devices are configured to consider only Communication Identities corresponding to their mutually available communication alternatives.

Devices also have a default mechanism to handle communications should all attempted methods fail to establish communications between interested Entities. In addition each Communication Identity has an associated preferred mechanism specified in the Ubiety Table.

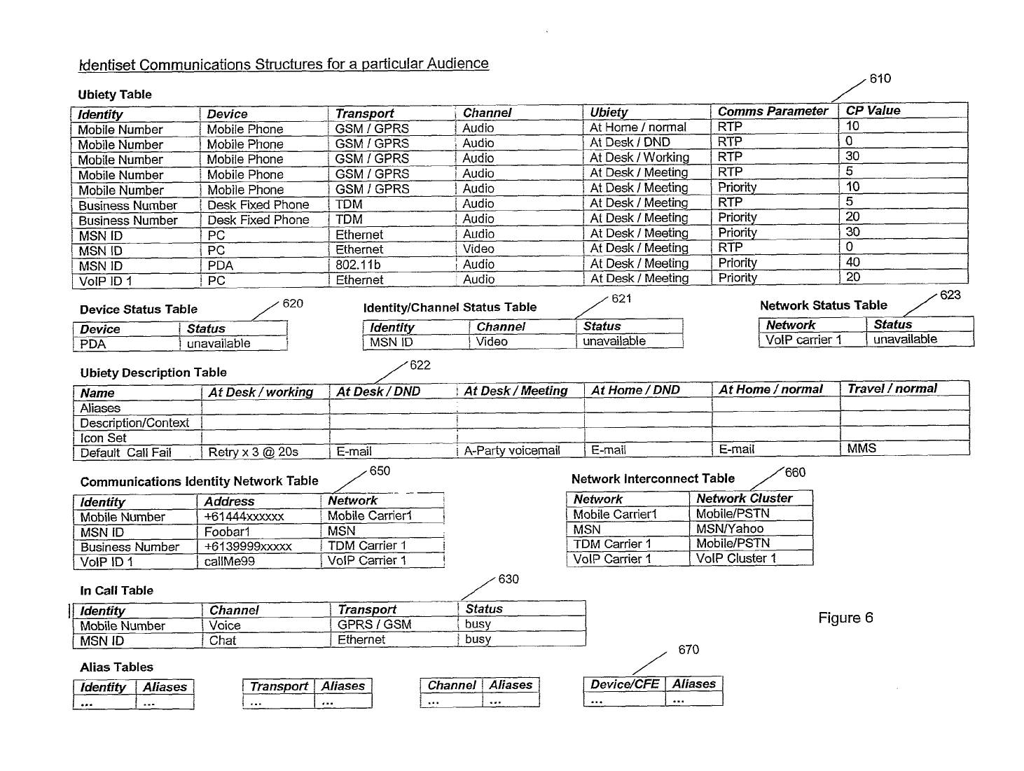

Several data structures that enable A-Party Call Control are associated with an Identiset. These are outlined in FIG. 6.

A “Ubiety Table” 610 specifies for each of an Entity's Ubieties a set of communications parameters, including RTPs, associated with each permutation of Communication Identity, Device, Transport and Channel via which communication with the Entity may be made. The set of communications parameters may include RTPs as well as priority and quality metrics which enable the A-Party to order and select from the available Communication Identities and to perform A-Party Call Control. Those skilled in the art will recognise that there are a wide variety of alternative communications parameters which may be applicable for this purpose, and that there may be more than one RTP, for example, one for “normal” calls, and another for when the B-Party is engaged in communication and has a “call waiting” facility. Those skilled in the art will also realise that quantitative parameters such as for example network capacity and latency may be used in addition to qualitative measures such as for example “high quality” or “fast connection”.

The Ubiety Table is conceptually a five-dimensional “hypercube”, the dimensions being Identity, Device/CFE, Transport, Channel and Ubiety, as the communications parameters may vary depending upon variation in any of these dimensions. Item 610 in FIG. 6 shows only a partial representation of such information.

A Presence State is represented by a locus of co-ordinate points in this hypercube space, as the set of table rows identified by a given set of Identity, Device/CFE, Transport, Channel and Ubiety values. Those skilled in the art will recognise that there are a number of ways such a data structure may be physically realised in a device.

Various Override Tables 620, 621, 622, 623 enable RTPs for a particular Communication Identity, Device, Transport, and/or Channel permutation and Ubiety combination in a Ubiety Table to be overridden in special circumstances.

For example, one or more non-zero RTPs for a particular Ubiety may be overridden to give a zero or non-default RTP value should:
one or more of the Entity's Devices/CFEs be unavailable as recorded in the Device Status Table 620, or
a channel of a Communication Identity be temporarily unavailable as recorded in the Identity/Channel Status Table 621, or
the Communication Identity be temporarily busy on a Transport/Channel as recorded in the In Call Table 622 (both Transport and Channel need to be specified because a busy status on either of these may have different effect on RTPs), or
there be a temporary technical failure with the Network associated with the Communication Identity as recorded in the Network Status Table 623, or
other conditions occur.

Alias Tables 670 provides aliases for each Communication Identity, Device, Transport, and/or Channel referred to in Overrides enabling interpretation of published Overrides based on Aliases.

A Ubiety Description Table 630 that contains detailed information of possible Ubieties. This lists each Ubiety and gives a detailed description of the Ubiety together with context information and icon sets that can be used on various devices to symbolise each Ubiety. It also contains for each Ubiety any Aliases by which that Ubiety may be referred to. It also contains for each Ubiety a default mechanism to handle communications should all attempted methods fail to establish communications. Those skilled in the art will realise that there may be additional context or presentation information that may be held in the Ubiety Description Table.

A Communication Identity Network Table 650 matches the Communication Identity to the actual Network and address that will be used for communications.

A Network Interconnect Table 660 lists the Network Clusters that each Network associated with a Communication Identity is known to connect to, for example that public GSM and TMD networks interconnect to form a greater public network.

Those skilled in the art will realise that this information is complex and that various combinations of automated and manual mechanisms are required to obtain and maintain this information. Such mechanisms are beyond the scope of this invention. However, even a simple subset of this information allows A-Party call control to make determinations regarding call setup based on the interconnection of available A-Party and B-Party identities.

Those skilled in the art will realise that Identisets may also contain information relating to non Communication Identities and other information relating to Communication Identities which is not illustrated in FIG. 6.

### DESCRIPTION OF THE PREFERRED EMBODIMENT

The preferred embodiment enables Entities to communicate with each other, automatically select the optimal communications path and direction, only allow calls to connect when answered by an Entity, and re-establish calls to improve communications if circumstances allow. It enables this by being aware of the full range of possible mutual communications methods and taking into account the Ubiety and communications Presence State(s) and characteristics of the Entity to be communicated with at or just before the instance of communication; and during communication. It does this in such a way that allows Entities to retain control of and provide differentiated published information to Audiences about mutual communications opportunities regarding themselves. It also provides a single consistent framework for managing a plurality of different communications methods that may be available to an Entity. It provides a method for preventing the initiation of real-time communications from completing, such as to a Network automatic answering system, without permission of the calling Entity.

In the preferred embodiment, the communications software is installed on Devices which are connected to communications Networks. Entities associate the communications software on their Devices with themselves and their Identities.

Entities develop and make available Identisets and possible Ubieties. Different Identisets (such as Public and Private) and sets of Ubieties may be made available to different Audiences. The Identisets include a Communications Table holding communications parameters, including RTPs, corresponding to possible permutations of available Communication Identities, Devices, Transports, Channels and possible Ubieties, tables linking Identities with Networks, Networks with Network Clusters, a Ubiety Table linking Ubieties, Identities Devices/CFEs, Transports and Channels with their respective sets of Aliases, and other information, and dynamically updated override tables. Identity information included in the Identiset may go through Claims transformation using rules in the Device, or other means, before being published in or associated with Identisets. In the preferred embodiment, the Communications Tables are stored in a directory database, hence, the directory and the hardware it is stored on provides both a Directory Storage and an Effective RTP Mechanism.

Entities publish Identisets in a public directory with entries based on the information they wish particular Audiences to receive. This includes information which facilitates communication to obtain further information if necessary from an Entity's associated Devices, for example network addresses of the Devices, or the address of the first node in a relay chain connected to a Device if required. This enables other Entities to locate them, exchange information and establish communication using the directory.

Entities publish their “Ubiety Alias” in a public directory. The mechanism described here makes it very difficult for an unauthorised observer correlating a publicly published Ubiety Alias with an Entity's particular observed Ubiety over time (such as by observing that a published Ubiety changes to “a” every time the Entity arrives at home)

Ubiety Aliases are published as an ambiguous element or figure (eg a, b, c, d, etc) not as “at home”, “at work”, etc. Several Aliases may correspond to the same Ubiety. This Ubiety information is available for all Parties to view. The Ubiety Table information inside Identisets provides the interpretation of the ambiguous Ubiety Alias for the particular A-Party Audience. For example an Entity may have an Identiset for a public Audience that shows that Ubiety Alias “a” corresponds to the Ubiety “unavailable” but an Identiset for a friends Audience that shows “a” corresponds to the Ubiety “at home”. The associated Communications Table, and Override Table information for each Entity may also be different but “a” will be available for all to see.

Ubiety Aliases are republished by Devices at random intervals as well as when an Entity's Ubiety changes, using the possible selection of Ubiety Aliases corresponding to the Entity's current Ubiety.

Ubiety Aliases corresponding to particular Ubieties are changed periodically at random intervals and the Communications Tables in the Identisets are updated accordingly and republished to Audiences. During the transition period (while some members but not all of an Audience have received the updated Identiset) the Communications Tables may contain the old Ubiety Alias information as well as the new. If an interested Entity's communications software finds a Ubiety Alias that it cannot correlate from its Ubiety Table, or an Entity believes it has an incorrect Ubiety Table, it can request a new Identiset directly from the publishing Entity.

Previously published Presence State information derived from a Ubiety published by the Device may be overridden in special circumstances (for example “off net”) and this information is included in the Identiset Communication Identity Override Tables and communicated as small, exception messages from the B-Party directly or made available to an Audience by the Effective RTP Mechanism as needed.

In a manner similar to Ubiety Aliases, published Overrides also refer to Identities Devices/CFEs, Transports and Channels via Aliases which are then resolved using the Communication Tables. Again, like Ubiety publication, Overrides are republished at random intervals and the Aliases are changes similarly.

Entities maintain as many Identisets as they have different Audiences, for example, a public Identiset, available to all users and which may be published in the directory where it is associated directly with directory entries associated with the Entity and private Identisets available only to Audiences authorised by the Entity.

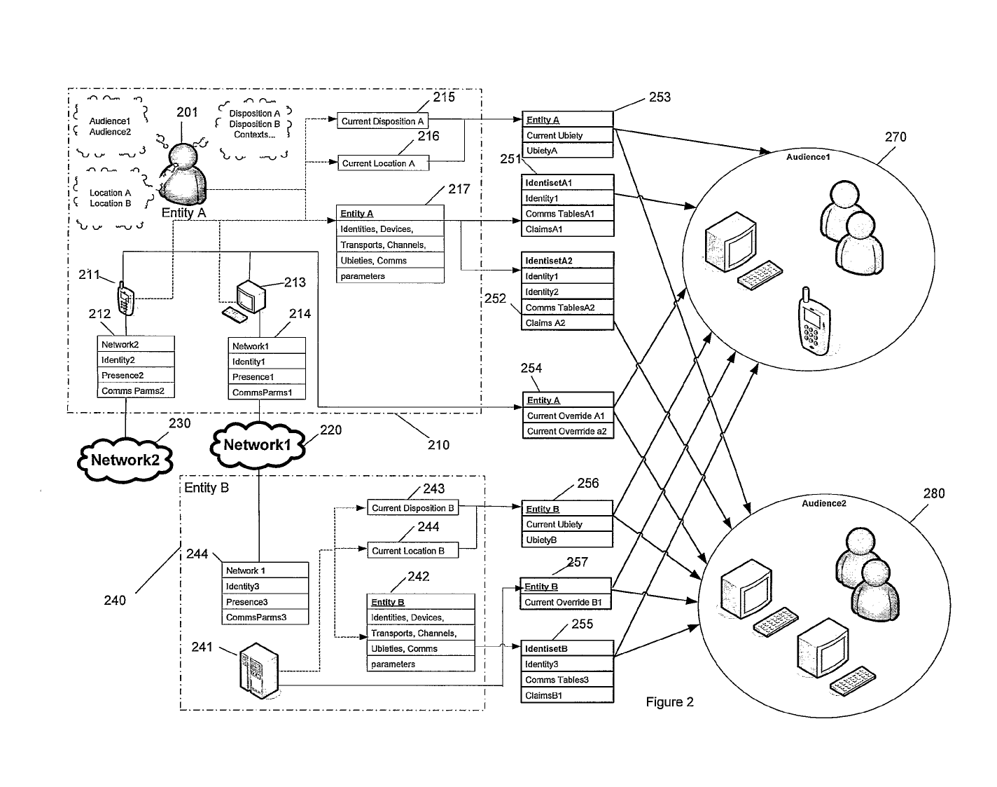

The relationship of Entities, Ubieties, Audiences and Context are described in more detail in relation to an example illustrated in FIG. 2. In FIG. 2, Group 210 corresponds to the set of items relating to Entity A 201. The Entity A 201 has a first device 211 in the form of a mobile phone and a second device 213 in the form of a computer. The computer 213 operates on a first network 220 with attributes indicated by table 214 i.e. the computer 213 is connected to a network, Network1 220, has a Communication Identity (Identity1) on Network1, a current presence, Presence1, and a set of communications attributes, including RTPs and quality measures indicated in table 214. Similarly mobile phone 211 operates on a second network Network2 230 with attributes indicated by table 212 i.e. the mobile phone 211 is connected to a network, Network2 230, has a Communication Identity (Identity2) on Network2, a current presence, Presence2, and a different set of communications attributes.

The Entity A 201 defines:
a number of Audiences (e.g. “Business”, “Friends”, “Family” etc.)
Ubieties including Locations (e.g. “In Office”, “Travelling”, “At Home” etc.), which are associated with particular Transports, Dispositions (e.g. “Working”, “In Meeting”, “Do Not Disturb” etc.) and Contexts (e.g. “On Leave”, “Board Meeting’, “Ill”) which may not directly provide input to Ubiety calculation, but may provide additional context information to facilitate communications from other Entities, and
contributes information to the communication data for Entity A 217, current disposition 215, and current location 216.

Similarly, the Devices 211,213 and Networks 220,230 contribute information to the communication data for Entity A 217, current disposition 215, and current location 216. The Communications data are schematically shown as a single set of information as Table 217 and corresponds to the possible communications methods and characteristics that can be used to communicate with Entity A including the first and second Communication Identities Identity1, Identity2 and the set of all Communications Tables corresponding to the first and second Communication Identities for all Audiences.

This information could also be used to create a single Identiset as it stores all the information that specifies how the Entity A may be communicated with. However, the system of the preferred embodiment is intended to allow Entities to maintain control over the information they provide to each Audience. Accordingly, the information relating to Entity A is transformed into IdentisetA1 251 and IdentisetA2 252. IdentisetA1 contains an Identity1 and claims made by the Entity. It contains the Communications Tables which govern the way other Entities may communicate with Identity1. An IdentisetA2 252 is of different construction to IdentisetA1 251, in that this Identiset contains information about two separate Communication Identities that are made available to a different Audience and its Communications Tables specify possible Presence States relating to the Identities. In this case, IdentisetA1 251 is intended for audience 270 and IdentisetA2 252 is intended for audience 280.

In addition to the Identisets, the user publishes a Current Ubiety 253, derived from the Current Disposition 215 and Current Location 216; and Override Table 254 which indicates temporary status changes of Device, CFE, Network, Transport and/or Channel.

As indicated in Table 610, these Ubieties will map to different sets of Communications Parameters (including RTPs) in the Communications Table. By publishing the Ubiety, the Entity 201 enables Audience1 and Audience2 to interpret the Communications Tables in the Identisets which they are authorised to view. For example, referring to Table 610, it can be seen that different Ubieties can be converted into different Presence States, depending on which Identiset the Audience possesses, thus mapping into different sets of current and Effective RTPs.

In addition to the Ubiety, there is provision for the publishing of Overrides 254. While the ability to publish override information will depend on the nature of networks and devices, this is intended to enable overrides of Presence States of the Ubiety Table information based on factors occurring in networks and/or devices. For example, it will be seen that networks 220 and 230 can affect the Presence States of particular identities for example, if there is a temporary network failure. Accordingly, the overrides allow RTPs specified by the Ubiety alone to be overridden.

A further Group 240 belongs to Entity 241. In this case the Entity 241 is a computer server. The server communicates on the Network 220 as indicated by table 244 i.e. the server 241 is connected to network Network1 220, has a Communication Identity (Identity3) on Network1, a current presence, Presence3, and its own set of communications attributes. These are used to form the communications data 242. This information is published as IdentisetB1 255. Similarly, the server software also contributes to the Current Location 244 (though it may rarely if ever change) and Current Disposition 243 from which the Current Ubiety and overrides are determined. The Current Ubiety 256 and Override 257 are published.

Note that in contrast to Identisets 251 and 252, Identiset 255 is made available to both Audience 1 270 and Audience 2 280. Ubieties 253 and 256 are made available to both audiences 270 and 280 so that they can use this information to obtain different RTP information based on the particular Communication Tables contained in the Identisets 251,252 and 255 to which they have access.

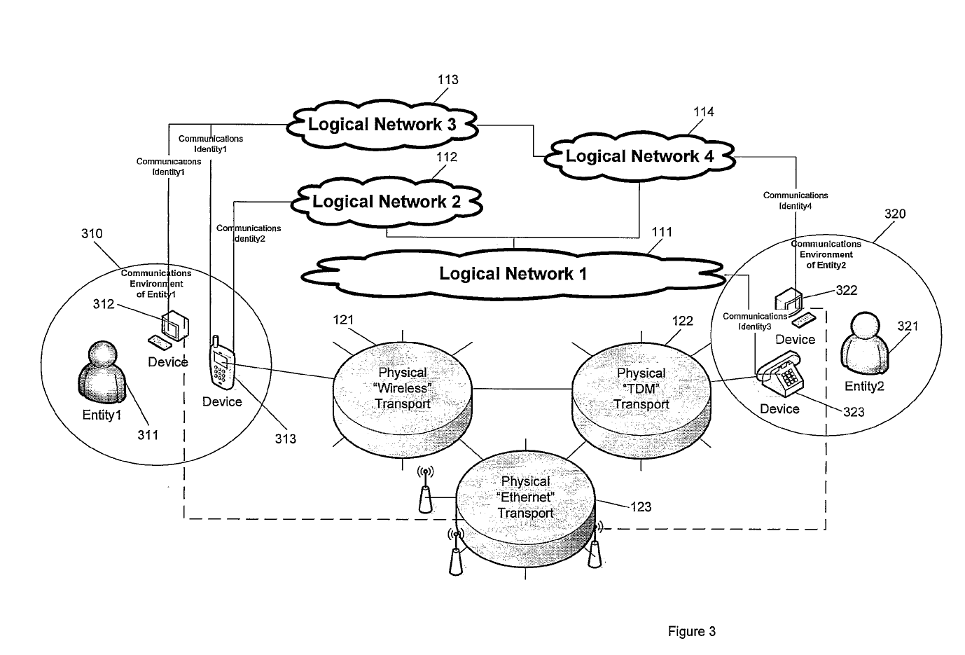

Entities interested in potentially communicating with other Entities identify those other Entities in the directory or by other means. The potential communications options between two Entities are illustrated in FIG. 3 which builds on the description of FIG. 1 showing the difference between Networks and Transports. In this case, Entity1 311 has a Communication Environment 310 and has a first Device 312, a second Device 313. The first Device 312 corresponds to a first Communication Identity and the second device 313 corresponds to both the first and second Communication Identity—in other words, the Entity 311 may initiate or receive communications on only device 313 using Communications Identity2 but on either Device 312, 313 using Communication Identity2.

Entity2's 321 communication environment 320 has a third device 322 having a first Communication Identity Communications Identity4 and a fourth device 323 having a second Communication Identity Communications Identity3. As indicated schematically, these Communication Identities correspond to different logical networks.

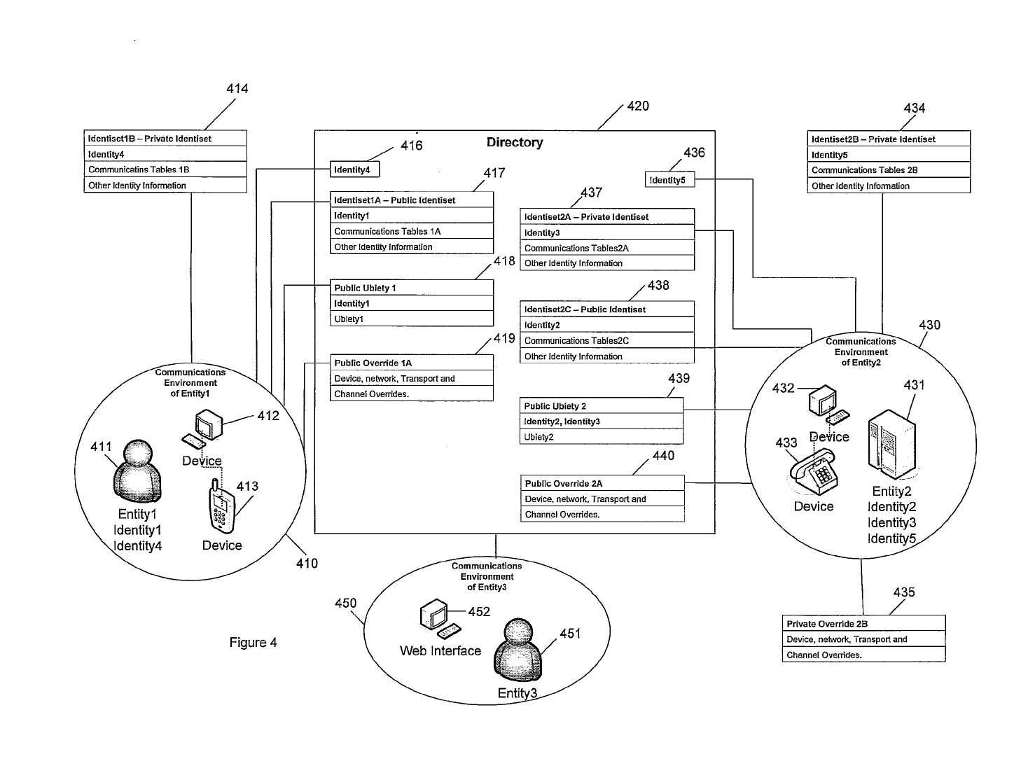

These communication options are expanded upon in relation to a schematic exemplary diagram of the communication options between Entities as shown in FIG. 4 which concentrates on the information stored in the Public Directory. In this embodiment, the Directory Storage and the Effective RTP Mechanism are combined into a single directory service. It would be appreciated that these can be published separately. Persons skilled in the art will appreciate that the Directory may be replicated, federated, and/or distributed, for example, using the peer-to-peer network. Persons skilled in the art will realise that the arrangement shown in FIG. 4 is merely exemplary and that various other configurations may apply depending on the requirements of particular Entities.

Referring to FIG. 4, there are three communication environments, 410, 430 and 450 corresponding to an Entity1 411, Entity2 431 and Entity3 451. The Entity1 411 has a first Device 412 and a second Device 413. The Entity 411 maintains Identity1 and Identity4 which correspond to the two Communication Identities corresponding to the two Devices 412 and 413.

In relation to Identity4, Entity1 411 maintains a private Identiset1B 414, comprising information relating to Identity4 including at least one Communication Identity of Identity4 enabling communications to be initiated with Entity1 411, Communications Tables described in FIG. 6 and such other Identity and other information as is desired to be exchanged by Entity1 and the Audience authorised to view Identiset4.

An entry indicating the existence of Identity4 of Entity1 416 is published in the Directory 420, however, there is no publicly published Identiset information regarding Identity4. Hence other Entities interested in Identity4 using the system know that in order to get the relevant Identiset and other information corresponding to Identity4 they need to contact Identity4 directly and request that information. The information in the directory about Identity4 416 contains enough contact information, such as the first node in a relay chain in a peer network, to enable a request to be made.

In the Directory 420, Entity1 411 has elected to publish a public Identiset1A 417 corresponding to Identity 1 and including Communications Tables and other identity information. Entity1 411 also publishes an Override Table 419 relating to itself and intended for all audiences. Entity 1 411 maintains Alias Tables within the Communications Tables located in Identisets 417 and 414 which enable resolution of the Aliases and interpretation of the Overrides.

Entity1 411 maintains a Ubiety Alias Ubiety1 and related information in a published table 418 so that its Ubiety can be communicated to Audiences.

Entity2 431 has three Identities: Identity2, Identity3 and Identity5. Entity2 431 is a computer enabled to communicate over a computer network 432 and a phone network 433. A private Identiset2B 434 and private Override2B 435 is maintained within the communications environment 430 of the Entity2 431. Entity2 431 publishes the existence of Identity5 436 in the Directory 420. Entity2 431 also publishes two further Identisets Identiset2A 437 and Identiset2C 438 in the Directory. In this case, the Identiset2A 437 containing Identity3 is a private Identiset but nevertheless is published in the Directory 420 as it is encrypted and may only be disclosed to members of its intended Audience.

In the case of Identiset2C 438, the Entity2 publishes a public Identiset 438 relating to Identity2. Entity2's public Ubiety Alias Ubiety2 is published in a publicly available table 439 together with the public Override Table 440. Authorised entities interpret the Public Ubiety and Override tables using the Identiset that they are authorised to receive, in order to determine the optimum method to communicate with Entity2 without Network or B-Party interference.

Entity3 451 while having a device 452 does not publish any Identisets or Ubieties. The Entity3 451 is able to access Directory 420 via a network interface 452 and obtain the publicly available information contained in the directory 420 or use their network interface to access private directory information which they are authorised to access or to request information directly from Entity and/or Entity2.

Where necessary, Entities request authorisation directly from the B-Party Entity of interest and then retrieve, view and use a relevant Identiset from the B-Party, although it will be appreciated that in some cases an A-Party will already be a member of an Audience and have access to the Identiset from a public directory. The request may include credential information to ensure the authenticity of the requesting Entity. The Entity receiving the request may check the authenticity of the requesting Entity and may then assign and authorise (an Entity may also pre-assigned authorisation) Entities to the relevant Audience and provide that Entity with the relevant Identiset, Override and Ubiety information.

Entities and their associated Devices may maintain local caches of Identity, Ubiety or Override information published in the directory which they are authorised to view.

As the state of Entity Devices, CFEs, Networks, Transports, Channels and Communication Identities and other Identity or associated information change, Entities update their Identiset information and apply such changes to the directory as necessary. Changes to an Entity's Ubiety and/or Communication Identities also may result in changes to the relevant Identiset(s), Ubiety and Override information in the directory.

An A-Party Entity seeking to establish or re-establish communications with another B-Party Entity initiates a request to communicate with the B-Party Entity on the A-Party's Device. The A-Party Device may retrieve the relevant B-Party Identiset, Ubiety and Override information using either Identiset and Ubiety information from a local cache, directory, or directly requested and retrieved Private Identiset, Ubiety and Override information from the B-Party. The A-Party Device interprets the information and hence obtains one or more Communication Identities together with associated Communications Tables including Effective RTPs. The A-Party Device matches these against its own communications capabilities and applies any internal rules, such as Entity preferences, cost or quality heuristics etc., to form an optimised ordered list of communication methods. The list of methods may then be displayed to the A-Party Entity as well as displaying discovered Entity context information associated with the B-Party Entity's Ubiety.

At the same time the A-Party device may perform a Current Status Check of the communications capabilities of itself and the one or more known B-Party Devices to confirm that the mutual communications capabilities are still current and that the B-Party's published or advised Ubiety and any Overrides are still current. This Current Status Check may include refreshing its own communications capabilities information; re-retrieving relevant B-Party Identiset, Ubiety and Override information using either Identiset and Ubiety information from a directory, or directly requested; re-retrieving Private Identiset, Ubiety and Override information from the B-Party; querying the relevant networks for current status information; and querying the B-Party device to check that the B-Party Devices are still online since it last published or advised its Ubiety etc. The A-Party Device can use this information in a number of ways to display to the A-Party Entity or adjust the actual Ubiety to be used to produce the optimised calling regime (including preventing the establishment of communication where the B-Party is off-line) if the published B-Party Ubiety is not current. This may result in the A-Party Device presenting an updated optimised list of communications options to the A-Party Entity to confirm or select from prior to attempting to initiate communications or the establishment/re-establishment regime may be generated and invoked automatically.

Dialling then occurs automatically or the A-Party Entity may then approve the selected communication method before dialling (for example selecting voice or instant-messaging and/or selecting a specific Network).

Where an A-Party Entity is communicating with a B-Party or has recently communicated with the B-Party, the A-Party may retrieve the B-Party's Identiset from a local cache of information (for example, stored on the Device) and, using one of the B-Party Communication Identities, only poll the one or more known B-Party Devices to confirm the Ubiety and override information prior to producing the communications regime.

The A-Party Device then seeks to establish/re-establish communications using the relevant communications Networks and Communication Identities defined by the Identiset and Ubiety. Should a method fail to establish communication in the duration derived from the RTP specified in the appropriate Communications Table the Device may terminate that communications method and then try the next communications method on the ordered list.

Should all communications methods fail the Device will revert to the method defined to be used in the case of failure which may be for example
to terminate the communications attempt,
retry the regime after an interval based on factors such as the B-Party's Ubiety,
use an A-Party based voicemail system as is described in the co-pending application WO 2005/022878 the disclosure of which is incorporated herein by reference,
direct the call to another answering machine number (such as a Network connected Server), which records and forwards a message. The answering machine number can be regarded as another B-Party Communication Identity at that time, not-withstanding that additional information may need to be sent giving the true B-Party Communications Identity and not just the answering machine Communications Identity—this could be done either by a parallel data transmission or by adding the B-Party Communications Identity to the end for the answering machine Communications Identity in the call setup), or
Use a non-real-time communication method such as Instant Messenger, e-mail, etc.

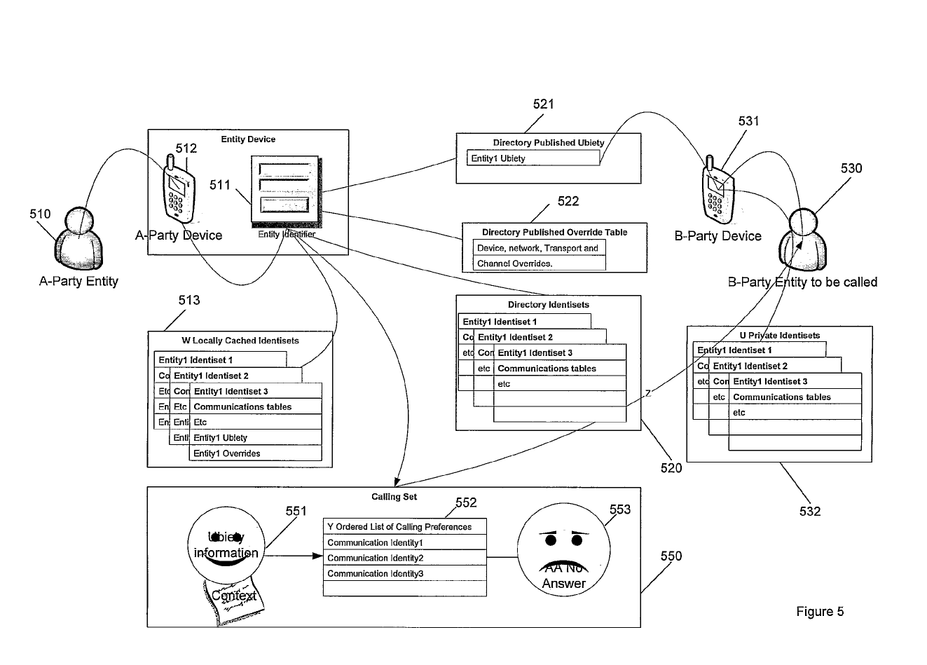

This process is further illustrated in FIG. 5. The B-Party Entity 530 has a B-Party Device 531 and a set of private Identiset information 532. These have previously been transformed by the B-Party device 531 into a Directory published Identiset 520 and Directory published Ubiety 521 and Override Table 522 which can be used to interpret the Communications Table contained within the Identiset 520.

When an A-Party 510 wishes to initiate a call the A-Party Entity 510 operates the Device 512 which uses an Entity dialler 511 to retrieve information about the B-Party entity that the A-Party is authorised to access, based on the Audience the B-Party has assigned the A-Party to. This information includes the published Identiset 520 and the published Override Table 522. The A-Party Entity can also access the published Ubiety 521. If the A-Party Entity has previously communicated with the B-Party Entity it may consult locally cached Identisets 513 as well as or instead of the Directory 520.

The Entity dialler 511 on the Device 512 then uses the Ubiety information to interpret the Communications Tables, any current overrides, and its own communications capabilities and communications state to obtain the information required to generate and possibly present a calling set 550 consisting of the Ubiety and context information of the B-Party 551, an ordered list of possible Communications Identities along with Effective RTPs for contacting the B-Party Entity 552 whether this be by Device 531 or some other Device associated with the B-Party Entity and rules as to what will happen in the case of call failure 553.

Alternatively, as a result of its analyses, the A-Party may determine that optimal communications (for example in terms of cost or timing) would require communications to be initiated by the B-Party Entity (perhaps at some future time) the A-Party device may request the B-Party to initiate communications. In this case the B-Party will assume the role of A-Party and perform the above process.

Additionally if, during communications, either party changes Ubiety (for example, the Entity's location has changed and additional devices/channels are available) or Override status (for example, a previous network degradation has been resolved) it can disclose such changes in the published identiset and overrides (e.g. in the case of the B-Party, 521 and 522) and attempt to re-establish communications based on the new communications circumstances. The process of re-establishment, is the same as that described above, with the additional requirement of a communications handover if required.

Those skilled in the art will appreciate that other techniques can be used to retrieve RTPs. For example Entities may have third party services authorised to retrieve and publish information on their behalf. This information may come from a variety of sources and not always directly from the Entity or its associated Devices but also, for example from the Network. Such as in the case where a third party service is authorised to view the Presence State of an Entity's Instant Messaging (IM) Communication Identity and so can poll the IM network directly itself and publish Presence State and RTP information.

As another example, when an A-Party seeks to call a B-Party, the A-Party device could contact a third party service and, based on the calendar of the B-Party (assuming direct authorised access of the A-Party to the B-Party calendar) retrieve a list of possible valid Communication Identities and associated effective RTPs (e.g. the B-Party's calendar publishes that the B-Party has the current Ubiety “at desk” now with its associated Communications Identities and Effective RTPs), such as the IM VoIP address and Effective RTP. The A-Party could then “click-to-dial” in their device. Based on the Effective RTP in the case of call failure (i.e. RTP timeout) the A-Party Device could then try a different number or fall back to the failed call mechanisms described above.

Further, the effective RTP for a given Communications Identity/channel may be dependent on the prevailing mutual communications capabilities of both Parties. For example, either party may define thresholds for cost or quality beyond which communication is not to take place (i.e. an effective RTP of zero). For example, “If the current network connection is not-broadband, then set the RTP for video communications to zero”; or “do not accept inbound mobile calls from networks where we incur cost”.

In addition, due to network quality or latency, the RTP could be set differentially depending on the channel used for communication—for example “Allow 10 seconds for the establishment of a video connection (i.e. need a good, low-latency connection), but 20 seconds for audio (i.e. can tolerate a poorer connection)”.

In using a current RTP that applies to a B-Party Communication Identity in order to derive an Effective RTP, the Communication Status Mechanism can only narrow the options for communications—i.e. to make the Effective RTP smaller than the current RTP, providing less time for communications to be established (possibly due to circumstances described in the above examples); or zero, removing the B-Party Communication Identity from the set of viable Communication Identities. To make an Effective RTP greater than the current RTP that applies to a B-Party Communication Identity would possibly permit interference from the Network or B-Party, negating the effectiveness of the A-Party call control mechanism.

Those skilled in the art will realise that relevant management functions are also provided to enable at least the following:
Subscription and un-subscription to the service,
Verification, certification and changing of Identities and Identity information,
Identiset transformation of Identities and the association and changing of relevant additional information with Identities,
The creation, encryption and publication of Identisets, ubieties and override information,
The establishment of Audiences and the distribution of encryption keys to Audiences
The provision of trust services to certify the reliability of information, information transports and directories, and
The addition and removal of authorised Identities, Devices, Networks, Network Groups, Transports and Channels and their association with Entities.

Those skilled in the art will realise that the directory may not be a centralised directory but could be distributed, peer-to-peer or take other forms. Devices may not all connect to the same point to update or view directory entries but may use a variety of access methods and points to gain access to the directory.

Those skilled in the art will realise that not all records or fields within the directory may be viewable by all users of the invention but that certain fields and records may be locked and encrypted and only viewable by certain users or certain classes of users.

Embodiments of the invention allow a call to be established as required to the multitude of Networks that Device CFEs allow.

For the purposes of this specification it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Australia or any other country.

Those skilled in the art will recognise that other embodiments of the invention are possible and that various other applications of the invention and modifications that can be made to the above embodiment without departing from the scope of the invention described herein.

1. A communication system for A-Party Call Control comprising:
a Directory Storage from which data can be retrieved by an A-Party Device and for storing one or more directory entries for each Entity intended to be communicated with using the communication system, at least one of the one or more directory entries of each Entity associated with one or more Communication Identities, whereby an authorised A-Party Device seeking to request, establish, or maintain communication with a B-Party can obtain at least one Communication Identity for the B-Party; and
a Communication Status Mechanism to enable an authorised A-Party Device to derive and confirm the current communications capabilities and one or more Effective Ring Timeout Parameters (RTPs) for at least one of said one or more B-Party Communication Identities and to determine whether there is at least one viable Effective RTP which can be employed to control an attempt to request, establish, or maintain communication with a B-Party.

2. The communication system as claimed in claim 1, further comprising an A-Party device configured to employ the Effective RTP so as avoid interference with the communication by other network elements.

3. The communication system as claimed in claim 1, further comprising an A-Party device configured to employ the Effective RTP so as to seek to improve at least one of the continuing cost, quality or other factor of the communications.

4. The communication system as claimed in claim 2, further comprising the A-Party device being operable to employ a plurality of Effective RTPs so as to attempt to establish a plurality of alternative available communications methods in parallel or series while avoiding interference.

5. The communication system as claimed in claim 1, wherein the Directory Storage is arranged to store one or more possible Ubieties for an Entity, and capable of optionally associating each Ubiety with the Entity's communications capabilities and one or more RTPs for each Communication Identity, whereby the current RTPs that apply to a B-Party Communication Identity can be determined from the current Ubiety, and the Communication Status Mechanism is configured to derive the one or more Effective RTPs at least in part from the current RTPs.

6. The communication system as claimed in claim 5, wherein the Communication Status Mechanism is configured to employ prevailing communications capabilities of at least the B-Party, together with the current RTPs that apply to a B-Party Communication Identity, to derive the one or more Effective RTPs.

7. The communication system as claimed in claim 6, wherein the Effective RTP is dependent on the prevailing mutual communications capabilities of both the A-Party and B-Party.

8. The communication system as claimed in claim 5, wherein the Communication Status Mechanism is configured to determine the Effective RTP at least in part based on at least one characteristic of a Channel or Network.

9. The communication system as claimed in claim 5, wherein the Directory Storage is configured to store the current Ubiety and any status overrides for an Entity.

10. The communication system as claimed in claim 1, wherein, the Communication Status Mechanism comprises a Current Status Mechanism which makes available the current Ubiety of a B-Party Entity from which the RTPs associated with the current Communications Identities of the B-Party Entity can be derived.

11. The communication system as claimed in claim 10, wherein the Current Status Mechanism also makes available status overrides of a B-Party which enable an A-Party Device to adjust the B-Party's current communications capabilities.

12. The communication system as claimed in claim 10, wherein the Current Status Mechanism is configured to cause storage of the current Ubiety and status overrides for a B-Party Entity in the Directory Storage.

13. The communication system as claimed in claim 10, wherein to alter the current RTPs in the Directory Storage based on any status overrides whereby the current RTPs provide Effective RTPs.

14. The communication system as claimed in claim 5, wherein the Directory Storage is configured to allow each Ubiety to be published as a Ubiety Alias that allows an A-Party device to derive communication capabilities without having access to the B-Party's Ubiety.

15. A communication method for A-Party call control, comprising:
an A-Party Device obtaining one or more Communication Identities for a B-Party;
the A-Party Device deriving and confirming the current communications capabilities associated with at least one of said one or more B-Party Communication Identities including whether there is at least one viable Effective Ring Timeout Parameter (RTP); and
if there is at least one viable Effective RTP:
selecting at least one Communication Identity having a viable Effective RTP with which to request, establish, or maintain communications; and
the A-Party Device controlling the attempt to request, establish, or maintain communications based on the mutual communications capabilities including at least one of the at least one Effective RTP associated with at least one selected Communication Identity.

16. The communication method as claimed in claim 15, wherein the A-Party Device derives the communication capabilities of the Communication Identities at least in part from at least one Ubiety associated with one or more of the Communication Identities.

17. The communication method as claimed in claim 15 or claim 16, wherein the A-Party Device confirms the current communication capabilities, at least in part by determining one or more changes in Ubiety or one or more Status overrides which may affect the B-Party Communication Status associated with the at least one Communications Identity for the B-Party Entity.

18. The communication method as claimed in claim 15, wherein the A-Party Device requests and establishes communication by:
performing a Current Status Check of the communications capabilities to confirm that the communications capabilities are still current and that the B-Party's published or advised Ubiety and any Overrides are still to thereby confirm that there is at least one Communications Identity with a viable Effective RTP which can be used to request, establish, or maintain communications;
informing the B-Party device of an intent to initiate communications based on the at least one selected Communication Identity and Channel combination associated with the B-Party Entity and receiving acknowledgement; and
negotiating with the B-Party device the parameters and conditions of communications, based on the at least one selected Communication Identity and Channel combination associated with the B-Party Entity.

19. The communication method as claimed in claim 18, wherein the Current Status Check includes one or more of:
refreshing the A-Party communication capabilities data;
re-retrieving relevant B-Party Identiset, Ubiety and Override information using either Identiset and Ubiety information from a directory or directly requested from the B-Party;
re-retrieving Private Identiset, Ubiety and Override information from the B-Party;
querying the relevant networks for current status information; and
querying the B-Party device, network services or other locations to check that the B-Party communications Services are still available since they were last published or advised by its Ubiety.

20. The communication method as claimed in claim 19, wherein the result of negotiation is:
i) the Communications Identity and Channel upon which communications should be initiated;
ii) the Effective RTP for the Communications Identity; and
iii) which Party and Party Device shall initiate and be responsible for coordinating the initiation of communications,
and then the A- or B-Party Device, selected by negotiation, controlling the attempt to transfer communications using the Communication Identity and Channel combination and the other-Party Entity accepting communications using the Identity and Channel combination.

21. The communication method as claimed in claim 15, wherein the A-Party Device maintains communication by:
informing the B-Party device of an intent to transfer communications based on the at least one selected Communications Identity and Channel combination associated with the B-Party Entity and receiving acknowledgement;
negotiating with the B-Party device the parameters and conditions of changed communications, based on the at least one selected Identity and Channel combination associated with the B-Party Entity.

22. The communication method as claimed in claim 21, wherein the result of negotiation is:
i) the Communications Identity and Channel upon which communications should be initiated;
ii) the Effective RTP for the Communications Identity; and
iii) which Party and Party Device shall initiate and be responsible for coordinating the initiation of communications.
and then the A- or B-Party Device, selected by negotiation, controlling the attempt to transfer communications using the new Identity and Channel combination and the other-Party Entity accepting communications using the new Identity and Channel combination;
the Devices synchronising communications with the new Communications Identity, Channel, Network, and/or Device combination; and
the A- or B-Party Device, selected by negotiation, controlling the attempt to maintain communications, terminating communications of the original Identity and Channel combination.

23. The communication method as claimed in claim 22, wherein the A-Party allows the B-Party to change the Communications Identity while engaged in a call.

24. The communication method as claimed in claim 22, wherein a party whose Current Communications Status changes may initiate Communications.

25. The communication method as claimed in claim 15, wherein an Entity has a plurality of devices and they work in concert to provide call maintenance.

26. The communication method as claimed in claim 15, wherein the step of selecting at least one Communication Identity is performed by the A-Party Device displaying one or more Communication Identities to the A-Party Entity and the A-Party Entity providing their selection to the A-Party Device.

27. The communication method as claimed in claim 15, wherein the step of selecting at least one Communication Identity is performed by the A-Party Device automatically based on one or more rules.

28. The communication method as claimed in claim 15, wherein the Ubiety is made available as a Ubiety Alias that allows the A-Party to derive communication capabilities without access to the Ubiety.

29. A communication method for A-Party Call Control comprising:
a B-Party Device disclosing at least one Communication Identity and corresponding Ubiety associated with a B-Party Entity to an A-Party Entity which may be seeking to request, establish, or maintain communications with the B-Party Entity;
the B-Party Device disclosing communications capabilities including one or more Effective RTPs associated with the at least one Communications Identity for the Entity;
the B-Party Device disclosing one or more changes in Ubiety or Status overrides which may affect the Current Communication Status associated with the at least one Communications Identity for the B-Party Entity; and
the B-Party Device participating in the requesting, establishing, or maintaining of communications based on the mutual communications capabilities including at least one viable Effective RTP of the one or more Effective RTPs of the at least one Communication Identity.

30. The communication method as claimed in claim 29, wherein the B-Party Device responds to requests for establishment of communication by offering to “call back” the A-Party and establish communication based on the negotiated set of communications capabilities.

31. The communication method as claimed in claim 30, wherein if the call-back occurs after a predetermined condition is met, a re-negotiation of communications capabilities occurs at that time.

32. The communication method as claimed in claim 29, wherein the B-Party Device discloses a Ubiety by publishing a Ubiety Alias.

33. An A-Party Device for A-Party call control, the A-Party Device being configured to:
obtain one or more Communication Identities for a B-Party;
derive and confirm the current communications capabilities associated with at least one of said one or more B-Party Communication Identities including whether there is at least one viable Effective Ring Timeout Parameter (RTP); and
if there is at least one viable Effective RTP:
enable selection of at least one Communication Identity having a viable Effective RTP with which to request, establish, or maintain communications; and
participate in an attempt to request, establish, or maintain communications based on the mutual communications capabilities including at least one of the at least one Effective RTP associated with at least one selected Communication Identity.

34. The A-Party Device as claimed in claim 33, wherein the A-Party Device is configured to derive the communication capabilities of the Communication Identities at least in part from at least one Ubiety associated with one or more of the Communication Identities.

35. The A-Party Device as claimed in claim 33, wherein the A-Party Device is configured to confirms the current communication capabilities, at least in part by determining one or more changes in Ubiety or one or more Status overrides which may affect the B-Party Communication Status associated with the at least one Communications Identity for the B-Party Entity.

36. The A-Party Device as claimed in claim 33, wherein the A-Party Device is configured to request and establish communication by:
performing a Current Status Check of the communications capabilities to confirm that the communications capabilities are still current and that the B-Party's published or advised Ubiety and any Overrides are still to thereby confirm that there is at least one Communications Identity with a viable Effective RTP which can be used to request, establish, or maintain communications;
informing the B-Party device of an intent to initiate communications based on the at least one selected Communication Identity and Channel combination associated with the B-Party Entity and receiving acknowledgement; and
negotiating with the B-Party device the parameters and conditions of communications, based on the at least one selected Communication Identity and Channel combination associated with the B-Party Entity to obtain one or more Communication Identities for a B-Party.

37. The A-Party Device as claimed in claim 33, wherein the A-Party Device displays one or more Communication Identities to the A-Party Entity and is configured to enable the A-Party Entity to provide a selection of the Communication Identity to the A-Party Device.

38. The A-Party Device as claimed in claim 33, wherein the A-Party Device is configured to select the Communication Identity automatically based on one or more rules.

39. The A-Party Device as claimed in claim 34, wherein the A-Party Device derives communication capabilities from a Ubiety Alias that allows the A-Party to communication capabilities without access to the B-Party's Ubiety.

40. A B-Party Device for A-Party call control, the B-Party Device configured to
disclose at least one Communication Identity and corresponding Ubiety associated with a B-Party Entity to an A-Party Device which may be seeking to communicate with the B-Party Entity;
disclose communications capabilities including one or more Effective RTPs associated with the each at least one Communication Identity, whereby an A-Party Device may initiate requesting, establishment, or maintenance of communications with the B-Party Entity;
disclose one or more changes in Ubiety or Status overrides which may affect the B-Party Communication Status associated with the at least one Communications Identity for the B-Party Entity; and
participate in the requesting, establishing, or maintaining of communications based on mutual communications capabilities including at least one viable effective RTP of the one or more Effective RTPs of at least one Communication Identity.
